(19) United States
(12) Patent Application Publication
(10) Pub. No.: US 2025/0208050 A1
(43) Pub. Date: Jun. 26, 2025

(54) METHOD FOR IMPROVING SELF-DRIVEN PHOTOELECTRIC DETECTION PERFORMANCE OF TIN SELENIDE SEMICONDUCTOR BASED ON BULK PHOTOVOLTAIC EFFECT THEREOF BY PRESSURE

(71) Applicant: JILIN UNIVERSITY, Changchun City (CN)

(72) Inventors: Quanjun LI, Changchun City (CN); Tingyu LIU, Changchun City (CN)

(73) Assignee: JILIN UNIVERSITY, Changchun City (CN)

(21) Appl. No.: 18/790,689

(22) Filed: Jul. 31, 2024

(30) Foreign Application Priority Data
Dec. 25, 2023 (CN) 202311802350.5

(51) Int. Cl. G01N 21/84

(52) U.S. Cl. CPC G01N 21/84; G01N 2021/8477; G01N 2201/061; G01N 2201/0696

(57) ABSTRACT

Provided is a method for improving self-driven photoelectric detection performance of a tin selenide semiconductor based on bulk photovoltaic effect thereof by pressure. The method includes: subjecting a metallic gasket to pre-pressing with a diamond anvil cell, then subjecting an obtained indentation center to punching; and preparing an insulating layer of a mixture of boron nitride and epoxy resin on a surface of an indentation region of a resulting metallic gasket with a sample chamber, then adding a tin selenide sample into the sample chamber, arranging two platinum sheets on a surface of the tin selenide sample, and connecting the two platinum sheets as electrodes to a photocurrent testing system, then subjecting the tin selenide sample to pressurization with the diamond anvil cell, and recording photoresponse of the tin selenide sample to illumination of a xenon lamp light source, where the two platinum sheets do not cross each other.

### CROSS-REFERENCE TO RELATED APPLICATIONS

This application claims foreign priority benefits under 35 U.S.C. § 119(a)-(d) to Chinese patent application No. 202311802350.5 filed on Dec. 25, 2023, the disclosure of which is incorporated herein by reference in its entirety.

### TECHNICAL FIELD

The present disclosure relates to the technical field of high-pressure regulation of photoelectric properties of functional materials, in particular to a method for improving self-driven photoelectric detection performance of a tin selenide semiconductor based on bulk photovoltaic effect thereof by pressure.

### BACKGROUND

Photoelectric effect, as the core theory of optoelectronic industry, is widely used in the fields of military detection, aerospace and production and life. In the traditional photovoltaic effect, a P-type semiconductor and an N-type semiconductor are adjacent to form a PN junction, and a current is generated by the generation and separation of electron-hole pairs induced by light. Through continuous research and improvement, the efficiency of the photovoltaic effect produced by such a heterojunction has been greatly improved, approaching the theoretical limit. Therefore, it is crucial to explore new ways to enhance the photovoltaic effect to further improve photoelectric conversion efficiency.

Bulk photovoltaic effect (BPVE) refers to the effect that an electric field along a certain direction is generated on the surface of a material when uniform strong light illuminates on the surface of the material. The BPVE only occurs in some crystals with inversion symmetry breaking, and its characteristic is that photoelectric conversion could be achieved without the PN junction. Therefore, it is expected to achieve a breakthrough in photoelectric conversion efficiency through the BPVE. However, the photoelectric conversion efficiency of the BPVE involved in the existing research is low, a main reason is that a generated built-in electric field is often small, and it is difficult to generate a considerable photocurrent if the resistance of the material itself is large. Therefore, semiconductors with smaller size and smaller band gap are considered to be efficient, it is a main research direction of the BPVE to find such semiconductor materials.

High-pressure, as an important external stimulus, is a powerful means to change the material structure and carrier characteristics. Under high-pressure, the band gap of the material tends to narrow and the resistance decreases, which makes it possible to enhance the BPVE response of photoelectronic functional materials by high-pressure means. At present, although the high-pressure has been proved to be the powerful means to adjust the photoelectric properties of materials, the regulation of the BPVE response of materials by the high-pressure has not been studied.

### SUMMARY

The present disclosure is intended to provide a method for improving self-driven photoelectric detection performance of a tin selenide semiconductor based on bulk photovoltaic effect thereof by pressure. According to the present disclosure, the separation and transmission of carriers and the crystal structure in the tin selenide (SnSe) semiconductor could be changed by employing a high-pressure photoelectric experiment technology, thus regulating the response condition of BPVE of the tin selenide semiconductor.

To achieve the above object, the present disclosure provides the following technical solutions.

The present disclosure provides a method for improving self-driven photoelectric detection performance of a tin selenide semiconductor based on bulk photovoltaic effect thereof by pressure, including the following steps:
subjecting a metallic gasket to pre-pressing with a diamond anvil cell, then subjecting an obtained indentation center to punching to obtain a metallic gasket with a sample chamber; and
preparing a coating of a mixture of boron nitride and epoxy resin on a surface of the sample chamber of the metallic gasket with the sample chamber, preparing an electric insulating layer on a surface of a non-sample chamber region of the metallic gasket with the sample chamber, then adding a tin selenide sample into the sample chamber, arranging two platinum sheets on a surface of the tin selenide sample, and connecting the two platinum sheets as electrodes to a photocurrent testing system, then subjecting the tin selenide sample to pressurization with the diamond anvil cell, and recording photoresponse of the tin selenide sample to illumination of a pulsed xenon lamp light source;
where, the two platinum sheets do not cross each other.

In some embodiments, the indentation center obtained after the pre-pressing has a thickness of 40 μm.

In some embodiments, the pre-pressing is performed at a pressure of 18 GPa to 22 GPa.

In some embodiments, the sample chamber obtained from the punching has a diameter of 240 μm and a thickness of 40 μm.

In some embodiments, a material for preparing the electric insulating layer is a dual-component epoxy adhesive Epoxy Molding Plastic (EMT).

In some embodiments, the photocurrent testing system includes a Keithley 2461 SourceMeter.

In some embodiments, the pulsed xenon lamp light source has a frequency of 0.01 Hz, and effective light illuminated to the tin selenide sample has a light power density of 2.7 mW/cm².

In some embodiments, the pressurization is performed under an initial pressure point of 0 GPa, a pressurization gradient of 1 GPa to 3 GPa, and a termination pressure point of 20.19 GPa.

The present disclosure provides a method for improving self-driven photoelectric detection performance of a tin selenide semiconductor based on bulk photovoltaic effect thereof by pressure, including the following steps: subjecting a metallic gasket to pre-pressing, then subjecting an obtained indentation center to punching to obtain a metallic gasket with a sample chamber; and preparing a boron nitride layer on a surface of the sample chamber of the metallic gasket with the sample chamber, preparing an electric insulating layer on a surface of a non-sample chamber region of the metallic gasket with the sample chamber, then adding a tin selenide sample into the sample chamber, arranging two platinum sheets on a surface of the tin selenide sample, and connecting the two platinum sheets as electrodes to a photocurrent testing system, then subjecting the tin selenide sample to pressurization with a diamond anvil cell, and recording photoresponse of the tin selenide sample to illumination of a pulsed xenon lamp light source; where the two platinum sheets do not cross each other. According to the present disclosure, the separation and transmission of carriers and the crystal structure in a tin selenide semiconductor could be changed by employing a high-pressure photoelectric experiment technology, thus regulating the response condition of BPVE of the tin selenide semiconductor. There is no need to introduce doping or adjust the material scale. The method is simple and efficient, and could be extended to the regulation of self-driven photoelectric detection performance of more photoelectric semiconductors with inversion symmetry breaking based on the BPVE.

### BRIEF DESCRIPTION OF THE DRAWINGS

FIG. 1 shows a schematic diagram of a device for improving self-driven photoelectric detection performance of a tin selenide semiconductor based on bulk photovoltaic effect thereof by a testing pressure according to an embodiment of the present disclosure, where 1 refers to a platinum sheet, 2 refers to an electric insulating layer, 3 refers to a metallic gasket, 4 refers to a ruby, and 5 refers to a boron nitride layer;

FIG. 2 shows a current-time curve of a tin selenide sample under different pressures with xenon lamp illumination (Example 1) and without xenon lamp illumination (Comparative example 1);

FIG. 3 shows a measurement schematic diagram of a high-pressure in-situ photoelectric I-V curve of the tin selenide sample under a pressure of 0 GPa to 8.72 GPa;

FIG. 4 shows a measurement schematic diagram of a high-pressure in-situ photoelectric I-V curve of the tin selenide sample under a pressure of 9.53 GPa to 20.19 GPa;

FIG. 5 shows a measurement schematic diagram of an open-circuit voltage (U_{oc}) change of the tin selenide sample during pressurization under xenon lamp illumination; and

FIG. 6 shows a measurement schematic diagram of a short-circuit current (I_{sc}) change of the tin selenide sample during pressurization under xenon lamp illumination.

### DETAILED DESCRIPTION

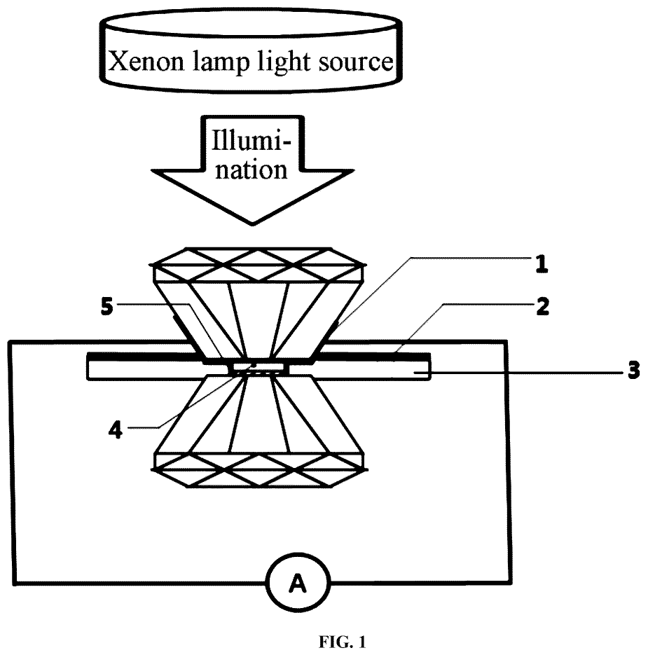

The present disclosure provides a method for improving self-driven photoelectric detection performance of a tin selenide semiconductor based on bulk photovoltaic effect thereof by pressure, including the following steps:
subjecting a metallic gasket to pre-pressing, then subjecting an obtained indentation center to punching to obtain a metallic gasket with a sample chamber; and
preparing an insulating layer of a mixture of boron nitride and epoxy resin on a surface of the sample chamber of the metallic gasket with the sample chamber, preparing an electric insulating layer on a surface of a non-sample chamber region of the metallic gasket with the sample chamber, then adding a tin selenide sample into the sample chamber, arranging two platinum sheets on a surface of the tin selenide sample, and connecting the two platinum sheets as electrodes to a photocurrent testing system (specific structure of which is shown in FIG. 1), then subjecting the tin selenide sample to pressurization with a diamond anvil cell, and recording photoresponse of the tin selenide sample to illumination of a xenon lamp light source;
where the two platinum sheets do not cross each other.

In the present disclosure, unless otherwise specified, all the raw materials involved are commercially available products well known to those skilled in the art.

In the present disclosure, after a metallic gasket is subjected to pre-pressing, an obtained indentation center is subjected to punching to obtain a metallic gasket with a sample chamber.

In some embodiments of the present disclosure, the metallic gasket is a T301 steel sheet.

In some embodiments of the present disclosure, the pre-pressing is performed at a pressure of 18 GPa to 22 GPa, preferably 19 GPa to 21 GPa, and more preferably 20 GPa.

In some embodiments of the present disclosure, the pre-pressing is performed by using a diamond anvil with an anvil face diameter of 500 μm.

In some embodiments of the present disclosure, the indentation center obtained after the pre-pressing has a thickness of 40 μm.

In some embodiments of the present disclosure, the punching treatment is performed by laser drilling. According to the present disclosure, there is no any special limitation on the process of the laser drilling, and a process well known to those skilled in the art may be adopted.

In some embodiments of the present disclosure, the sample chamber obtained from the punching has a diameter of 240 μm, and a thickness of 40 μm.

In the present disclosure, after a metallic gasket with a sample chamber is obtained, a boron nitride layer is prepared on a surface of the sample chamber of the metallic gasket with the sample chamber, an electric insulating layer is prepared on a surface of a non-sample chamber region of the metallic gasket with the sample chamber, then a tin selenide sample is added into the sample chamber, two platinum sheets are arranged on a surface of the tin selenide sample, and the two platinum sheets as electrodes are connected to a photocurrent testing system, then the tin selenide sample is subjected to pressurization with a diamond anvil cell, and photoresponse of the tin selenide sample to illumination of a pulsed xenon lamp light source is recoded; where the two platinum sheets do not cross each other.

According to the present disclosure, there is no any special limitation on the preparation process of the boron nitride layer, and a process well known to those skilled in the art may be adopted. In some embodiments of the present disclosure, the boron nitride layer has a thickness of 10 μm. In embodiments of the present disclosure, the boron nitride layer is specifically prepared by a process including the following steps: filling the surface of the sample chamber of the metallic gasket with the sample chamber with a boron nitride powder, then conducting pre-pressing to 20 GPa again to make the boron nitride powder closely attached to the T301 steel sheet, so as to achieve an insulating layer between a platinum electrode and the metallic gasket and prepare the boron nitride layer.

In some embodiments of the present disclosure, the electric insulating layer has thickness of 0.1 mm. In some embodiments, a material for preparing the electric insulating layer is a dual-component epoxy adhesive EMT.

According to the present disclosure, there is no any special limitation on the addition of the tin selenide sample, and a process well known to those skilled in the art may be adopted to ensure that the tin selenide sample is fully filled in the sample chamber.

In some embodiments of the present disclosure, the photocurrent testing system includes a Keithley 2461 SourceMeter.

In some embodiments of the present disclosure, a 0.1 mm enameled wire is adopted for connection.

In some embodiments of the present disclosure, the diamond anvil cell adopts a diamond anvil with an anvil face diameter of 500 μm.

In some embodiments, before pressurization, the method also includes placing a ruby as a calibration standard material on the anvil face of the diamond anvil cell.

In some embodiments of the present disclosure, the pressurization is performed under an initial pressure point of 0 GPa. In some embodiments of the present disclosure, the pressurization is performed under a pressurization gradient of 1 GPa to 3 GPa, preferably 1.5 GPa to 2.5 GPa, and more preferably 1.8 GPa to 2.2 GPa. In some embodiments of the present disclosure, the pressurization is performed under a termination pressure point of 20.19 GPa.

In some embodiments of the present disclosure, the pulsed xenon lamp light source has a frequency of 0.01 Hz, and effective light illuminated to the tin selenide sample has a light power density of 2.7 mW/cm².

The method for improving self-driven photoelectric detection performance of a tin selenide semiconductor based on bulk photovoltaic effect thereof by pressure provided by the present disclosure will be described in detail below in conjunction with examples, but these examples should not be understood as limiting the scope of the present disclosure.

### Example 1

A T301 steel sheet was subjected to pre-pressing with a diamond anvil cell with an anvil face diameter of 500 μm (the pre-pressing was performed at a pressure of 22 GPa) to obtain an indentation center with a thickness of 40 μm. A sample chamber having a circular hole with a diameter of 240 μm and a thickness of 40 μm was drilled in the indentation center by laser to obtain a metallic gasket with the sample chamber.

A surface of the sample chamber of the metallic gasket with the sample chamber was filled with a boron nitride powder. The resulting system was conducted pre-pressing to 20 GPa again to make the boron nitride powder closely attached to the T301 steel sheet, so as to achieve an insulating layer between a platinum electrode and the metallic gasket and prepare a boron nitride layer with a thickness of 10 μm. An electrical insulation layer (a preparation raw material thereof was a dual-component epoxy adhesive EMT) with a thickness of 0.1 mm was prepared on a surface of a non-sample chamber region of the metallic gasket with the sample chamber. Then a tin selenide sample was added into the sample chamber. And then two platinum sheets (the two platinum sheets did not cross each other) were arranged on a surface of the tin selenide sample. The two platinum sheets were used as electrodes to contact with a paint-removed part of a 0.1 mm enameled wire, and were connected to a Keithley 2461 SourceMeter. After connecting a photocurrent testing system, a ruby was placed on a anvil face of the diamond anvil cell and used as a calibration standard material. The tin selenide sample was subjected to pressurization with the diamond anvil cell (the initial pressure point was 0 GPa, the pressurization gradient was 2 GPa, and the termination pressure point was 20.19 GPa). The photoresponse of the tin selenide sample to illumination of a pulsed xenon lamp light source (the pulsed xenon lamp light source had a frequency of 0.01 Hz, and effective light illuminated to the tin selenide sample had a light power density of 2.7 MW) was recorded.

### Comparative Example 1

The comparative example was performed with reference to Example 1, except that there is no xenon lamp light source illumination.

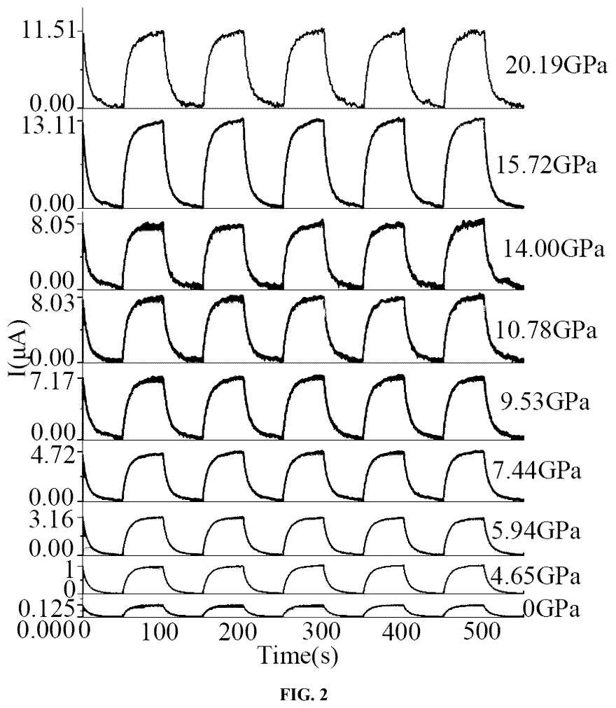

FIG. 2 shows a current-time curve of a tin selenide sample under different pressures with xenon lamp illumination (Example 1) and without xenon lamp illumination (Comparative example 1). As can be seen from FIG. 2, with the increase of pressure, the response photocurrent of the tin selenide semiconductor increases.

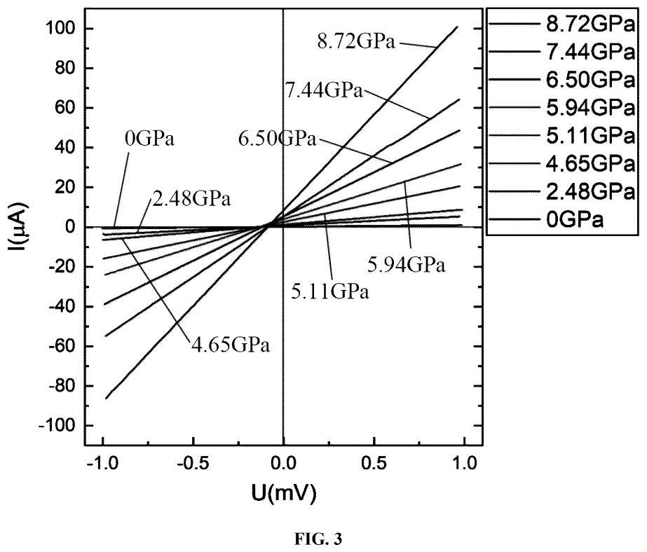

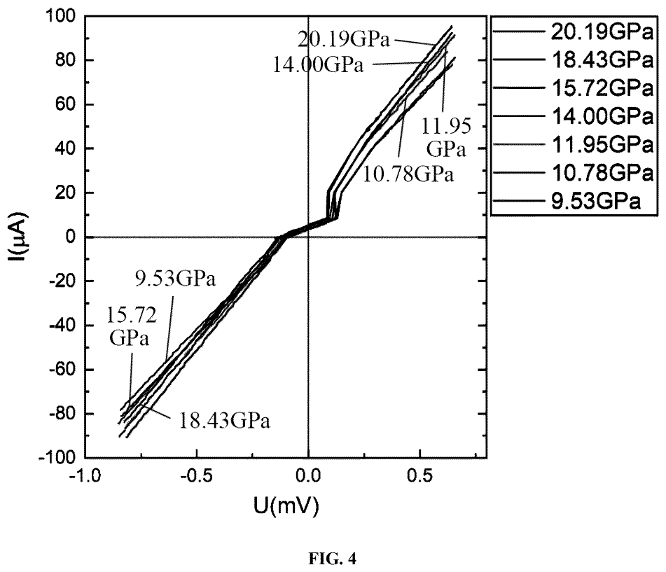

FIG. 3 shows a measurement schematic diagram of a high-pressure in-situ photoelectric I-V curve of the tin selenide sample under a pressure of 0 GPa to 8.72 GPa. FIG. 4 shows a measurement schematic diagram of a high-pressure in-situ photoelectric I-V curve of the tin selenide sample under a pressure of 9.53 GPa to 20.19 GPa. As can be seen from FIG. 3 and FIG. 4, before 9.53 GPa, a short-circuit current of the tin selenide semiconductor gradually increases with the pressure, and an open-circuit voltage gradually decreases with the pressure, which indicates that the resistance of the semiconductor decreases rapidly during this process; with continued pressurization, the open-circuit voltage and short-circuit current show a relatively stable fluctuation state with no monotonous increase or decrease.

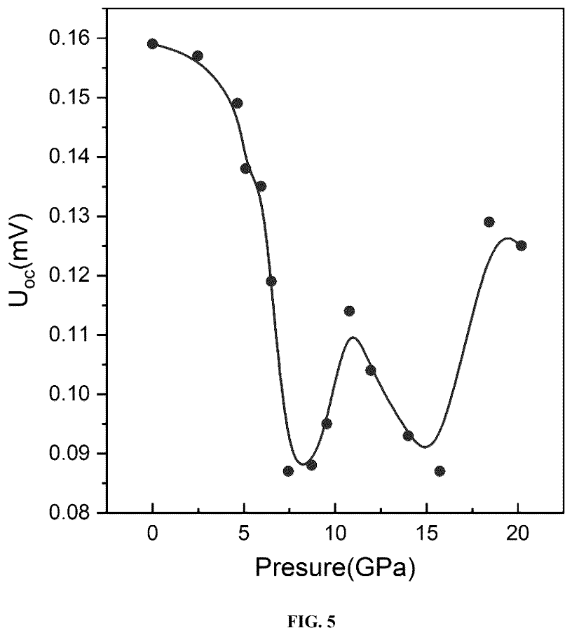

FIG. 5 shows a measurement schematic diagram of an open-circuit voltage (U_{oc}) change of the tin selenide sample during pressurization under xenon lamp illumination. As can be seen from FIG. 5, during the pressurization, the open-circuit voltage under illumination first drops and then fluctuates in a certain range.

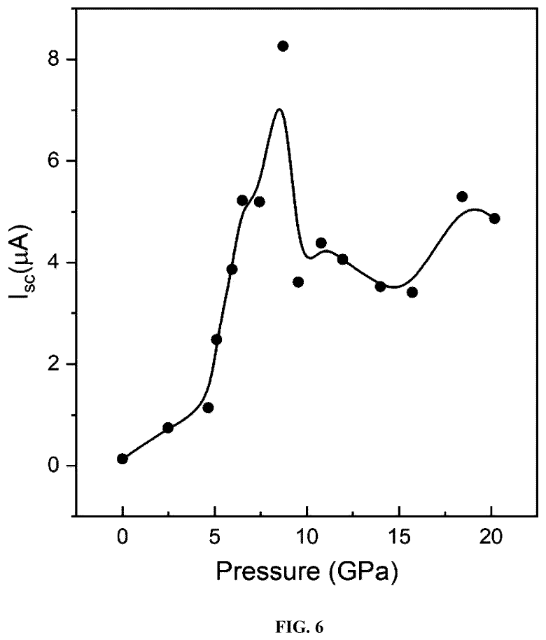

FIG. 6 shows a measurement schematic diagram of a short-circuit voltage (I_{sc}) change of the tin selenide sample during pressurization under xenon lamp illumination. As can be seen from FIG. 6, during the pressurization, the short-circuit voltage of SnSe under illumination first rises and then fluctuates in a certain range.

The above descriptions are merely preferred embodiments of the present disclosure. It should be noted that a person of ordinary skill in the art may further make several improvements and modifications without departing from the principle of the present disclosure, but such improvements and modifications should be deemed as falling within the protection scope of the present disclosure.

What is claimed is:

1. A method for improving self-driven photoelectric detection performance of a tin selenide semiconductor based on bulk photovoltaic effect thereof by pressure, comprising the following steps:
subjecting a metallic gasket to pre-pressing with a diamond anvil cell, then subjecting an obtained indentation center to punching to obtain a metallic gasket with a sample chamber; and
preparing a coating of a mixture of boron nitride and epoxy resin on a surface of the sample chamber of the metallic gasket with the sample chamber, preparing an electric insulating layer on a surface of a non-sample chamber region of the metallic gasket with the sample chamber, then adding a tin selenide sample into the sample chamber, arranging two platinum sheets on a surface of the tin selenide sample, and connecting the two platinum sheets as electrodes to a photocurrent testing system, then subjecting the tin selenide sample to pressurization with the diamond anvil cell, and recording photoresponse of the tin selenide sample to illumination of a xenon lamp light source;
wherein the two platinum sheets do not cross each other.

2. The method of claim 1, wherein the indentation center obtained after the pre-pressing has a thickness of 40 μm.

3. The method of claim 1, wherein the pre-pressing is performed at a pressure of 18 GPa to 22 GPa.

4. The method of claim 1, wherein the sample chamber obtained from the punching has a diameter of 240 μm and a thickness of 40 μm.

5. The method of claim 1, wherein a material for preparing the electric insulating layer is a dual-component epoxy adhesive Epoxy Molding Plastic (EMT).

6. The method of claim 1, wherein the photocurrent testing system comprises a Keithley 2461 SourceMeter.

7. The method of claim 1, wherein the xenon lamp light source has a frequency of 0.01 Hz, and effective light illuminated to the tin selenide sample has a light power density of 2.7 mW/cm2.

8. The method of claim 1, wherein the pressurization is performed under an initial pressure point of 0 GPa, a pressurization gradient of 1 GPa to 3 GPa, and a termination pressure point of 20.19 GPa.

9. The method of claim 2, wherein the pre-pressing is performed at a pressure of 18 GPa to 22 GPa.
